(19) United States
(12) Patent Application Publication
(10) Pub. No.: US 2024/0071203 A1
(43) Pub. Date: Feb. 29, 2024

(54) Automatic Unconscious Alert Device

(71) Applicant: John Jaeger, Irvine, CA (US)

(72) Inventor: John Jaeger, Irvine, CA (US)

(21) Appl. No.: 18/045,502

(22) Filed: Oct. 11, 2022

Related U.S. Application Data
(60) Provisional application No. 63/400,156, filed on Aug. 23, 2022.

(51) Int. Cl. G08B 25/00; G08B 7/06; G08B 21/04

(52) U.S. Cl. CPC G08B 25/008; G08B 7/06; G08B 21/0415; G08B 21/0461

(57) ABSTRACT

The present invention relates to an automatic unconscious alert device that is preferably a mobile application for a smart device comprised of a motion detection system that sends an alert if a user is detected as motionless for a specific time interval that can be selected by a user. Before the alert is sent to at least one secondary user chosen by the first user, a reset system may be activated which may allow the user to reset the motion detection system and prevent the sending of the alert if it is erroneous.

### CROSS-REFERENCE TO RELATED APPLICATION

The present application claims priority to, and the benefit of, U.S. Provisional Application No. 63/400,156, which was filed on Aug. 23, 2022, and is incorporated herein by reference in its entirety.

### FIELD OF THE INVENTION

The present invention relates generally to the field of life-monitoring devices. More specifically, the present invention relates to an automatic unconscious alert device that is preferably a mobile application for a smart device comprised of a motion detection system that sends an alert if a user is detected as motionless for a specific time interval that can be selected by a user. Before the alert is sent to at least one secondary user chosen by the first user, a reset system may be activated which may allow the user to reset the motion detection system and prevent the sending of the alert if it is erroneous. Accordingly, the present disclosure makes specific reference thereto. Nonetheless, it is to be appreciated that aspects of the present invention are also equally applicable to other like applications, devices, and methods of manufacture.

### BACKGROUND

Many elderly individuals and even younger individuals live alone, with a dependent, with a helpless relative, and sometimes in remote areas or farms. Said individuals, or their helpless dependent(s), can fall, pass out unconscious and die if not rescued by others in time. As a result, many senior citizens carry a personal notification device that includes a button that can be pressed to summon help when in distress, or which is activated if they fall. However, a user of such devices cannot push the button of the device if they become unconscious before, during, or after a fall. While some devices are designed to summon assistance in the event a fall is detected, there is currently no device that will summon assistance when a user passes out or becomes unconscious while sitting or lying down motionless for a predetermined period of time.

Therefore, there exists a long-felt need in the art for a device that aids an individual in being rescued if they become unconscious. In addition, there exists a long-felt need in the art for an automatic unconscious alert device that alerts at least one other individual when a user becomes unconscious. There also exists a long-felt need in the art for an automatic unconscious alert device that does not require that a user manually activate the device to send the unconscious alert.

The subject matter disclosed and claimed herein, in one embodiment thereof, comprises an automatic unconscious alert device. The device is preferably a mobile application and/or software for a smart device. The device is comprised of a motion detection system that sends an alert if a user is detected as motionless for a specific time interval that can be selected by a user. Before the alert is sent to at least one secondary user chosen by the first user, a reset system may be activated which may allow the user to reset the motion detection system and prevent the sending of the alert if it is erroneous.

In this manner, the automatic unconscious alert device of the present invention accomplishes all of the foregoing objectives and provides a device that aids an individual in being rescued if they become unconscious. Further, the device alerts at least one other individual when a user becomes unconscious. However, while doing so, the device does not require that a user manually activate the device to send the unconscious alert.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automatic unconscious alert device preferably comprised of a mobile application for a smart device and/or software for a smart device. The device is comprised of a motion detection system that sends an alert if a user is detected as motionless for a specific time interval. Before the alert is sent, a reset system may be activated which may allow a user to reset the motion detection system and prevent the sending of the alert if it is erroneous.

The motion detection system allows a user to configure a plurality of features of the device such as setting a time interval. The time interval can range from any length such as, but not limited to, minutes and hours in differing embodiments. The device also detects the motion of the smart device the device is installed on such that if the motion of the smart device is not detected during the time interval, an alert will be sent.

A user can use the configuration setting to choose at least one secondary user that the alert is sent to such as, but not limited to, a family member, a neighbor, a caregiver, emergency services, police, a doctor, etc. In one embodiment, the user can configure the device to send a plurality of alerts simultaneously to a plurality of secondary users such that multiple secondary users can be alerted using one alert. The alert may be in a plurality of forms in differing embodiments such as, but not limited to, a pre-written text message, a phone call with a pre-recorded voice message, a pre-written email, etc., that can be recorded and/or written by the user of the device. The alert is then sent to the smart device of at least one secondary user.

To prevent an erroneous alert, which arises in a situation when the smart device of the user is motionless but the user is not unconscious, the device is comprised of a reset system. The reset system can be configured to have a time interval that begins once motionlessness is first detected or after the first time interval has expired but before the alert is sent. The system sends at least one alert to the user. The alert may be an audible noise, a text message, a phone call, an email, a vibration of the smart device, etc. Once a user to alerted, they can reset the system and prevent the alert from sending by performing a reset by shaking the smart device, pressing a button on the device interface, etc.

Accordingly, the automatic unconscious alert device of the present invention is particularly advantageous as provides a device that aids an individual in being rescued if they become unconscious by alerting at least one other individual when a user becomes unconscious. While doing so, the device does not require that a user manually activate the device to send the unconscious alert. In this manner, the automatic unconscious alert device overcomes the limitations of existing fall alerting devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of features and/or functions of one potential embodiment of an automatic unconscious alert device of the present invention in accordance with the disclosed architecture;

FIG. 2 illustrates a graphical view of features and/or functions of a motion detection system of one potential embodiment of an automatic unconscious alert device of the present invention in accordance with the disclosed architecture;

FIG. 3 illustrates a graphical view of features and/or functions of a reset system of one potential embodiment of an automatic unconscious alert device of the present invention in accordance with the disclosed architecture; and

FIG. 4 illustrates a flow chart of one potential method of using one potential embodiment of an automatic unconscious alert device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that enables an individual to be rescued if he or she becomes unconscious. In addition, there exists a long-felt need in the art for an automatic unconscious alert device that alerts at least one other individual when a user becomes unconscious. There also exists a long-felt need in the art for an automatic unconscious alert device that does not require that a user manually activate the device to send the unconscious alert.

The present invention, in one exemplary embodiment, is comprised of an automatic unconscious alert device preferably comprised of a mobile application for a smart device and/or software for a smart device. The device is comprised of a motion detection system that sends an alert if a user is detected as motionless for a specific time interval. Before the alert is sent, a reset system may be activated which may allow a user to reset the motion detection system and prevent the sending of the alert if it is erroneous.

The motion detection system allows a user to configure a plurality of features of the device. A user can set a time interval that can range from any length such as, but not limited to, minutes and hours in differing embodiments. The device also detects the motion of the smart device the device is installed on, such that if the motion of the smart device is not detected during the time interval, an alert will be sent.

A user can use the configuration setting to choose at least one secondary user that the alert is sent to such as, but not limited to, a family member, a neighbor, a caregiver, emergency services, police, a doctor, etc. In one embodiment, the user can configure the device to send a plurality of alerts simultaneously to a plurality of secondary users, such that multiple secondary users can be alerted using one alert. In differing embodiments, the alert may be in a plurality of forms in differing embodiments such as, but not limited to, a pre-written text message, a phone call with a pre-recorded voice message, a pre-written email, etc., that can be recorded and/or written by the user of the device. The alert is then sent to the smart device of at least one secondary user.

An erroneous alert may arise in a situation when the smart device of the user is motionless, but the user is not unconscious. To prevent this, the device is comprised of a reset system that can be configured to have a time interval that begins once motionlessness is first detected or after the first time interval has expired but before the alert is sent. The system sends at least one alert to the user. The alert may be an audible noise, a text message, a phone call, an email, a vibration of the smart device, etc. Once a user is alerted, they can reset the system and prevent the alert from sending by performing a reset by shaking the smart device, pressing a button on the device interface, etc.

Accordingly, the automatic unconscious alert device of the present invention is particularly advantageous as provides a device that aids an individual in being rescued if they become unconscious by alerting at least one other individual when a user becomes unconscious. While doing so, the device does not require that a user manually activate the device to send the unconscious alert. In this manner, the automatic unconscious alert device overcomes the limitations of existing fall alerting devices known in the art.

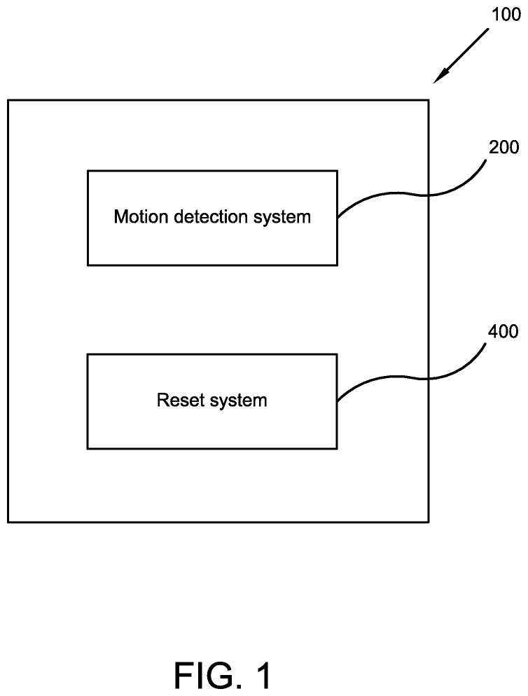

Referring initially to the drawings, FIG. 1 illustrates a graphical view of features and/or functions of one potential embodiment of an automatic unconscious alert device 100 of the present invention in accordance with the disclosed architecture. The device 100 is preferably comprised of a mobile application for a smart device and/or software for a smart device. The term smart device includes, but is not limited to, a smartphone, a smartwatch, a tablet, a computer, etc. The device 100 is comprised of a motion detection system 200 that sends an alert 350 if a user is detected as motionless for a specific time interval. Before the alert 350 is sent, a reset system 400 may be activated by the user to reset 460 the motion detection system 200 and prevent the sending of the alert 350 if the alert is erroneous.

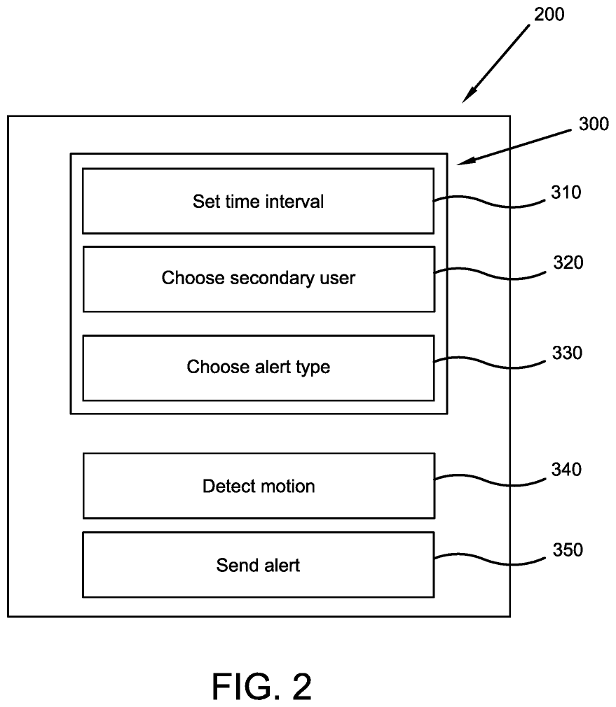

FIG. 2 illustrates a graphical view of features and/or functions of a motion detection system 200 of one potential embodiment of an automatic unconscious alert device 100 of the present invention in accordance with the disclosed architecture. The motion detection system 200 allows a user to configure 300 a plurality of features of the device 100. One feature includes setting at least one time interval 310. The time interval 310 may be any time interval desired by the user, which can be set by the configuration 300 feature of the device 100 interface. The time interval 310 is preferably at least one minute. However, the time interval 310 can range from any length such as, but not limited to, minutes and hours in differing embodiments. The device 100 detects any motion 340 of the smart device the device 100 is installed on such that if the motion of the smart device is not detected during the time interval 310, an alert 350 will be sent.

A user can use the configuration 300 feature to also choose at least one secondary user 320 that the alert 350 is sent to via text message, email, phone call, mobile app notification, etc. The secondary user 320 may be an individual such as, but not limited to, a family member, a neighbor, a caregiver, emergency services, police, a doctor, etc., or any other person chosen by the user. In one embodiment, the user 320 can configure the device 100 to send at least one alert 350 simultaneously to a plurality of secondary users 320. In this manner, multiple secondary users can be alerted using at least one alert 350.

The configuration 300 setting also allows a user to choose the alert type 330. The alert 350 may be in a plurality of forms in differing embodiments such as, but not limited to, a pre-written text message, a phone call with a pre-recorded voice message, a pre-written email, etc., that can be recorded and/or written by the user of the device 100. The alert 350 is then sent to the smart device of at least one secondary user 320 using Wi-Fi, cellular data, etc. In one embodiment, the alert 350 is also accompanied by an audible noise and/or vibration relayed to the smart device of the second user 320. In this manner, the second user's 320 attention is more easily called to the alert 350.

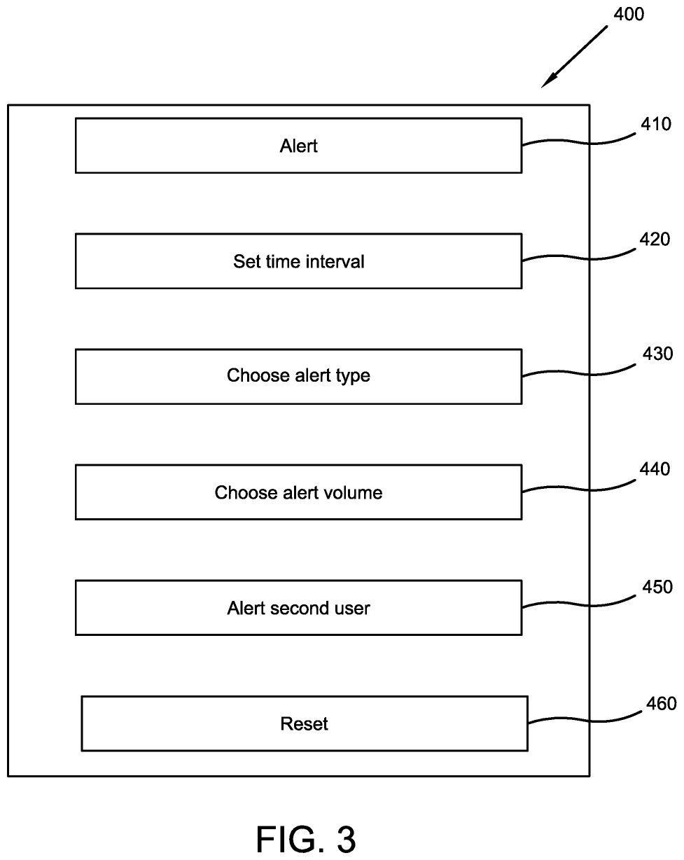

FIG. 3 illustrates a graphical view of features and/or functions of a reset system 400 of one potential embodiment of an automatic unconscious alert device 100 of the present invention in accordance with the disclosed architecture. To prevent an erroneous alert 350, which arises in a situation when the smart device of the user is motionless but the user is not unconscious, the device 100 is comprised of a reset system 400. The reset system 400 can be configured to have at least one time interval 420 that is at least one minute in length or longer. The time interval 420 may begin once motionlessness is first detected 340 or after the first time interval 310 has expired, but before the alert 350 is sent. The system 400 sends at least one alert 410 to the user. The user can choose the alert type 420. The alert 410 may be an audible noise, a text message, a phone call, an email, a vibration of the smart device the device 100 is installed on, etc. A user can also choose the volume of the audible alert 440 and the intensity of the vibration alert 450. Once a user is alerted 410, they can reset the system 200 and prevent the alert 350 from sending by performing a reset 470. The reset 470 may be accomplished by shaking the smart device the device 100 is installed on, pressing a button on the device 100 interface, etc.

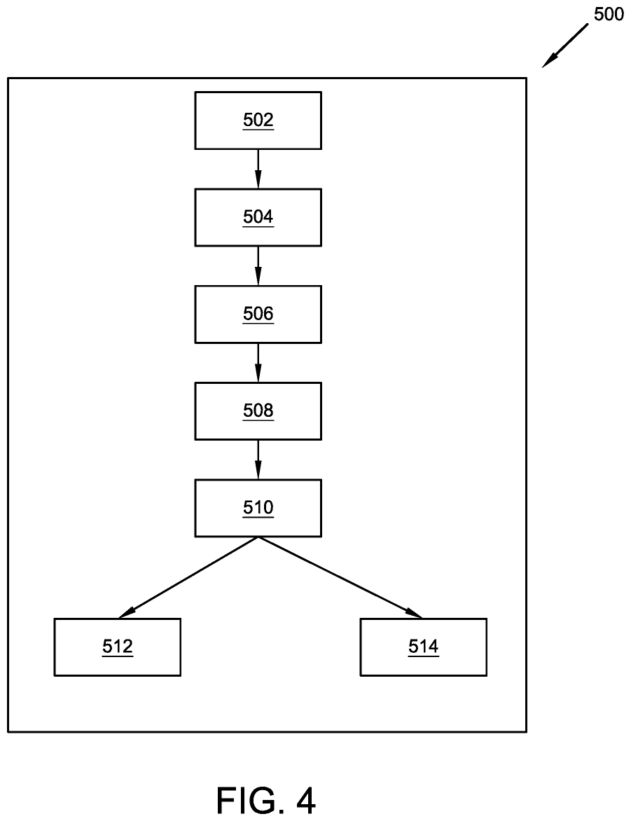

FIG. 4 illustrates a flow chart of one potential method 500 of using one potential embodiment of an automatic unconscious alert device 100 of the present invention in accordance with the disclosed architecture. The device 100 is also comprised of a method of use 500. First, a user installs and activates the device 100 on a smart device [Step 502]. Then, the user configures the time interval 310 by selecting a time interval in minutes or hours [Step 504]. The user also inputs contact information of at least one secondary user 320 into the device 100 [Step 506]. The user may also choose the type of alert 330 the device 100 will send to at least one secondary user 320 [Step 508]. Next, the motion detection system 200 can be activated manually or automatically, wherein the device 100 detects a lack of motion of the smart device [Step 510]. If the device 100 detects a lack of motion for longer than the time interval 310, an alert 350 will be sent [Step 512]. However, if the alert 350 is erroneous and the user is not unconscious, a user is alerted via at least one alert 410 before an alert 350 is sent to a secondary user and can reset 460 the system 200 by shaking the smart device the device 100 is installed on and/or interacting with the interface of the device 100 [Step 514].

In another embodiment of the present invention, the mobile application may include a timer that defaults to a nine-hour period but may be adjusted by the user, and the app may be voice activated. The device may charge during the nine-hour sleep period and then resume one hour timer reset periods. Further, the mobile application is not limited to use on a phone and may be used on any other electronic device including, without limitation, a bracelet.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “automatic unconscious alert device” and “device” are interchangeable and refer to the automatic unconscious alert device 100 of the present invention.

Notwithstanding the foregoing, the automatic unconscious alert device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the automatic unconscious alert device 100 as shown in the FIGS. are for illustrative purposes only, and that many other sizes and shapes of the automatic unconscious alert device 100 are well within the scope of the present disclosure. Although the dimensions of the automatic unconscious alert device 100 are important design parameters for user convenience, the automatic unconscious alert device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automatic unconscious alert device comprising:
a mobile application;
a motion detection system that sends an alert to a second user; and
a reset system that cancels the sending of the alert.

2. The automatic unconscious alert device of claim 1, wherein the mobile application is installed on a smart device.

3. The automatic unconscious alert device of claim 2, wherein the motion detection system detects the motion of the smart device.

4. The automatic unconscious alert device of claim 3, wherein if motion of the smart device is not detected within a time interval, the alert is sent.

5. An automatic unconscious alert device comprising:
a mobile application;
a first time interval;
a configuration setting;
a motion detection system that sends an alert; and
a reset system that prevents the sending of the alert if the motion detection system attempts to send the alert erroneously.

6. The automatic unconscious alert device of claim 5, wherein the configuration setting allows a user to set the first time interval in minutes or hours.

7. The automatic unconscious alert device of claim 5, wherein the configuration setting allows a user to choose a first secondary user the alert is sent to.

8. The automatic unconscious alert device of claim 7, wherein the alert can also be sent to a second secondary user.

9. The automatic unconscious alert device of claim 8, wherein the configuration setting allows a user to choose a type of the alert.

10. The automatic unconscious alert device of claim 9, wherein the type of alert is a pre-written text message, a phone call with a pre-recorded voice message, or a pre-written email.

11. The automatic unconscious alert device of claim 9, wherein the alert is comprised of an audible noise.

12. The automatic unconscious alert device of claim 9, wherein the alert is comprised of a vibration.

13. The automatic unconscious alert device of claim 7, wherein the alert is sent to the first secondary user if motion of a smart device that the mobile application is installed on is not detected within the first time interval.

14. The automatic unconscious alert device of claim 5, wherein the reset system is comprised of a second time interval that is activated after the first time interval is expired but before the alert is sent.

15. The automatic unconscious alert device of claim 14, wherein the reset system alerts the user via a reset alert within the second time interval.

16. The automatic unconscious alert device of claim 15, wherein the reset alert is an audible sound.

17. The automatic unconscious alert device of claim 15, wherein the reset alert is a vibration.

18. The automatic unconscious alert device of claim 14, wherein the alert is sent if the reset system is not reset within the second time interval.

19. The automatic unconscious alert device of claim 18, wherein the reset system can be reset by shaking a smart device the mobile application is installed on or touching a button on an interface of the mobile application.

20. A method of using an automatic unconscious alert device, the method comprising the steps of:
installing the automatic unconscious alert device on a smart device;
configuring a first time interval;
inputting a secondary user;
choosing an alert type;
activating the automatic unconscious alert device; and
resetting a motion detection system of the automatic unconscious alert device if necessary.
